(19) United States
(12) Patent Application Publication
(10) Pub. No.: US 2024/0002142 A1
(43) Pub. Date: Jan. 4, 2024

(54) ASSEMBLY COMPRISING A CAPSULE INTENDED TO RECEIVE A SUBSTANCE FOR PREPARING A BEVERAGE, AND A FILM LID

(71) Applicant: BRAIN CORP SA, Leudelange (LU)

(72) Inventor: Olivier Brivois, Differdange (LU)

(21) Appl. No.: 18/039,458

(22) PCT Filed: Nov. 30, 2021
(86) PCT No.: PCT/EP2021/083646

§ 371 Date: May 30, 2023

(30) Foreign Application Priority Data
Nov. 30, 2020 (LU) 102246

(51) Int. Cl. B65D 85/804; B32B 27/10; B32B 29/00; B32B 27/36; B32B 7/12; B65D 65/46

(52) U.S. Cl. CPC B65D 85/8052; B32B 27/10; B32B 29/005; B32B 27/36; B32B 7/12; B65D 65/466; B32B 2439/70; B32B 2307/718; B32B 2307/7246; B32B 2307/7244; B32B 2435/02; B32B 2307/7163; B32B 2250/03; B32B 2307/7376; B32B 2307/7265

(57) ABSTRACT

An assembly having a capsule intended to receive a substance for preparing a beverage, the capsule comprising a body having a side wall bordered on either side by a bottom and by a rim surrounding an opening of the body, the assembly including an upper film lid associated with the rim in order to cover the opening by forming, in the body, a loading compartment of the substance in the capsule, the opening being equipped with a way of perforating the upper film lid under the effect of an increase of pressure in the compartment (13) in order to allow the beverage to flow through the opening, the upper film lid (12) including a layer made of microfibrillated cellulose, MFC.

The invention relates to an assembly comprising a capsule intended to receive a substance for preparing a beverage and an upper film lid forming, in said capsule, a loading compartment of said substance.

Capsules comprising a body which can be made of plastic or ductile material such as aluminium are known, said body having a side wall bordered on either side by a bottom and by a rim surrounding an opening of said body, the upper film lid being intended to be associated with said rim in order to cover the opening.

In particular, after association of the upper film lid, the substance can be loaded in the compartment, in particular through an opening formed in the bottom of the capsule and which can be covered by a lower film lid in order to close said compartment after said loading.

In particular, at least the upper film lid allows ensuring a sealed closure of the capsule, in particular by forming a barrier against oxygen and moisture, in order to be able to preserve the organoleptic characteristics of the substance before preparing the beverage.

Such capsules are in particular intended for preparing a hot beverage of the coffee, tea or infusion type. To do this, a capsule is installed in the housing of a machine provided for this purpose, where it is held by a piston during the passage of an extractor liquid, for example, hot water, through it and the substance it contains.

In particular, the piston allows an injection of the extractor liquid through the bottom of the capsule, for example by perforating a lower film lid, the flow of the beverage through the opening requiring breaking the upper film lid.

To do this, the opening is equipped with means for perforating the upper film lid under the effect of an increase of pressure in the compartment in order to allow the flow of the beverage through said opening. In particular, the pressure induces a displacement of the upper film lid on the perforation means.

The known embodiments do not allow obtaining a good compromise between the pressure to be exerted on the upper film lid, which must not be too significant for the quality of the beverage, and the sealing of said film lid which must be sufficient, and this in particular in relation to a biodegradable and/or compostable film lid.

Indeed, an upper film lid which is too resistant requires a coarser grinding of the substance to increase the pressure, but leads to a beverage which is too watery, and an upper film lid which can be too easily torn does not provide the sufficient friction for the quality of the beverage extracted through said film lid, in particular by limiting the formation of foam for a coffee.

The invention aims at improving the prior art by proposing in particular an upper film lid which has good sealing properties, in particular against oxygen and moisture, while being able to be optimally broken relative to the quality of the prepared beverage, said film lid can also be advantageously biodegradable and/or compostable.

To this end, the invention proposes an assembly comprising a capsule intended to receive a substance for preparing a beverage, said capsule comprising a body having a side wall bordered on either side by a bottom and by a rim surrounding an opening of said body, said assembly comprising an upper film lid associated with the rim in order to cover the opening by forming, in said body, a loading compartment of the substance in said capsule, said opening being equipped with means for perforating the upper film lid under the effect of an increase of pressure in the compartment in order to allow the flow of the beverage through said opening, the upper film lid comprises a layer based on microfibrillated cellulose MFC.

Other particularities and advantages of the invention will appear in the following description, made with reference to the appended figures, in which:

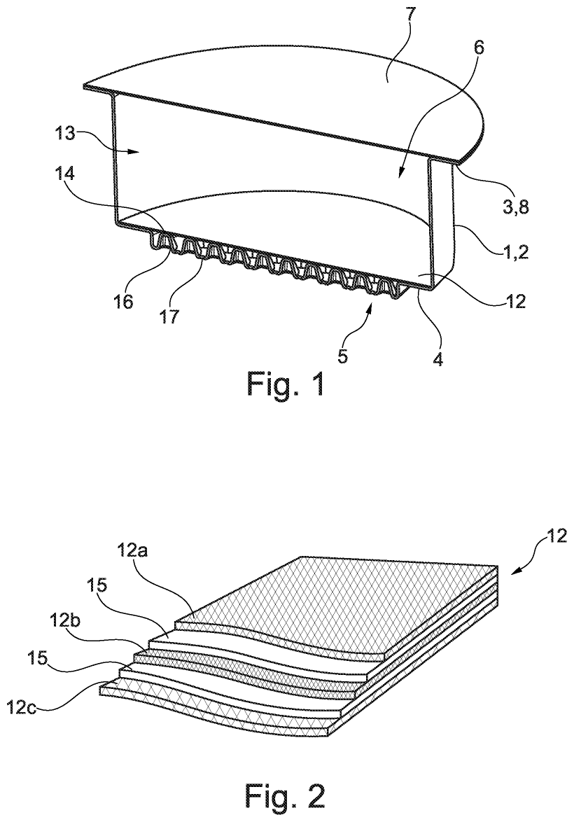

FIG. 1 represents, in section, an assembly according to one embodiment of the invention;

FIG. 2 represents, in cutaway perspective, the structure of an upper film lid according to one embodiment of the invention.

In relation to these figures, an assembly comprising a capsule 1 intended to receive a substance for preparing a beverage is described below.

The capsule 1 comprises a body which can be made of plastic or ductile material such as aluminium, said body having a side wall 2 bordered on either side by a bottom 3 and by a rim 4 surrounding an opening 5 of said body.

In relation to FIG. 1, the body of the capsule 1 has a geometry of revolution about a central axis forming a side wall 2 which is globally inscribed in a cylinder between the bottom 3 and the rim 4.

In the represented embodiment, in relation to a body of a capsule 1 made by moulding a plastic material, the bottom 3 comprises an opening 6 intended to be covered by a lower film lid 7, said film lid being intended to be pierced when preparing a beverage.

In particular, the bottom 3 has a collar 8 forming an upper annular wall surrounding the side wall 2, the lower film lid 7 being associated on said wall to close the opening 6. Alternatively, the capsule 1 can comprise a solid bottom 3 which is pierced during the preparation of the beverage.

The assembly comprises an upper film lid 12 which is associated with the rim 4 to cover the opening 5 by forming, in said body, a loading compartment 13 of the substance in said capsule.

In particular, after association of the upper film lid 12, the substance can be loaded through the opening 6 in the compartment 13 formed in the side wall 2, then the lower film lid 7 can be associated on the collar 8 in order to close said compartment before preparing the beverage.

The upper film lid 12 allows ensuring a sealed closure of the capsule 1, in particular by forming a barrier against oxygen and moisture, in order to be able to preserve the organoleptic characteristics of the substance stored in the compartment 13 before the use thereof.

In particular, the capsule 1 is intended for preparing a hot beverage of the coffee, tea or infusion type. To do this, the capsule 1 can be disposed in the housing of a machine provided for this purpose, in order to be held therein by a piston provided with pins to pierce the bottom 3 of said capsule. Furthermore, the bottom 3 is crossed by at least one spindle to inject extractor liquid, in particular hot water, into the substance contained in the capsule 1.

The injection of the liquid induces an increase of the pressure in the compartment 13, the opening 5 being equipped with means 14 for perforating the upper film lid 12 under the effect of this increase in order to allow the flow of the beverage through said opening.

In particular, the pressure induces a displacement of the upper film lid 12 on the perforation means 14 which are arranged adjacent outside the compartment 13.

In the represented embodiment, the rim 4 forms an annular wall on which the periphery of the upper film lid 12 is associated, the perforation means 14 being associated with said wall while being separated from the compartment 13 by said upper film lid.

In particular, the perforation means 14 comprise protrusions which are directed towards the upper film lid 12, said protrusions being carried by a plate 16 having orifices 17 allowing the passage of the beverage.

FIG. 1 represents an embodiment in which the plate 16 is made in one piece with the rim 4 of the capsule 1 by substantially extending in the extension of said rim with the protrusions 14 substantially in the plane of the annular wall and the orifices 15 disposed under said plane.

The upper film lid 12 has at least one layer 12b based on microfibrillated cellulose MFC. The upper film lid 12 may also comprise a sealing layer 12c on the rim 4, said layer being able to be adapted to the heat and/or cold sealing.

Advantageously, the MFC layer 12b can be in the form of a paper layer formed with microfibrillated cellulose so as to be highly fibrillated, while being in particular translucent, so as to be able to be particularly oxygen barrier.

The microfibrillated cellulose consists of cellulose microfibrils that are individualised or in the form of aggregates. These microfibrils generally have a diameter of 2 to 20 nanometres, and a length in the range of a few micrometres. The microfibril aggregates are composed of several cellulose microfibrils agglomerated with each other.

The production of MFC is based on the release of the elements constituting the secondary wall of lignocellulosic fibres by mechanical means coupled to enzymatic or chemical pre-treatments. The used fibres can be unbleached or bleached chemical pulp, mechanical pulp produced from wood, recycled pulp . . . .

According to exemplary embodiments, the thickness of the MFC layer 12b is comprised between 30 and 70 μm.

According to exemplary embodiments, the MFC layer 12b has an oxygen transmission rate of at most 5 cm³/m²·day·atm, and in particular less than 1 cm³/m²·day·atm, according to the ASTM D3985 standard and an area density comprised between 40 and 90 g/m².

Furthermore, the MFC layer 12b can have a water vapour transmission rate which is less than 100 g/m²·24 h, measured according to the ASTM E96 standard.

Moreover, the MFC layer 12b may have been treated to improve its resistance to moisture, for example by means of a moisture barrier coating.

According to one embodiment, a water vapour barrier lacquer is applied on the MFC layer 12b to give it a water vapour transmission rate which is less than 50 g/m²·24 h, in particular less than 5 g/m²·24 h and more particularly less than 1 g/m²·24 h.

In particular, the MFC layer 12b allows obtaining an upper film lid 12 having a high area density and a sufficient oxygen tightness for the barrier function.

Moreover, the applicant noted that the bearing of this MFC layer 12b on the perforation means 14 would cause a multitude of small break areas which sufficiently weakens the upper film lid 12 to limit the dispensing pressure of the beverage and promote the friction of the extracted beverage through said film lid.

In relation to FIG. 2, the upper film lid 12 has at least one second layer 12a made of fibrous material which is associated on the MFC layer 12b, the layers 12a, 12b each having an area density and an oxygen transmission rate, the area density of the second layer 12a being lower than the area density of the MFC layer 12b, the oxygen transmission rate of the MFC layer 12b being lower than the oxygen transmission rate of the second layer 12a.

The layers 12a, 12b, 12c of the film lid 12 can be associated with each other by a glue film 15. According to one embodiment, a biodegradable adhesive, for example based on corn starch, can be used in order to facilitate the elimination by composting of the waste generated by the capsule 1.

Advantageously, the second layer 12a is based on cellulosic fibres, in particular in the form of a filter-type paper, said second layer being able to be associated on the MFC layer 12b opposite to the perforation means.

This embodiment of the lower film lid 12 allows combining an MFC layer 12b having a high area density and a sufficient oxygen tightness for the barrier function, with a second layer 12a of lower area density and without specific barrier function, in which the fragility of an MFC layer 12b of limited thickness can be compensated by the thickness of the second layer 12a, said second layer also being able to have a function of filtering the extracted beverage to eliminate the substance residues therefrom.

Moreover, the applicant has found that this combination of layers 12a, 12b improved the breakage of the upper film lid 12 on the perforation means 14, in particular by increasing the stretching of the MFC layer 12b.

Advantageously, the thickness of the second layer 12a is greater than the thickness of the MFC layer 12b. According to exemplary embodiments, the thickness of the second layer 12a is comprised between 60 and 100 μm.

According to exemplary embodiments, the second layer 12a is porous while having an air permeability which is greater than 500 l/m²·s, according to the ISO 9237 standard. The area density of the second layer 12a can be comprised between 10 and 40 g/m², the area density of the upper film lid 12 possibly being comprised between 100 and 120 g/m².

The invention allows considering a biodegradable and/or compostable upper film lid 12, in particular in combination with a sealing layer 12c based on polylactic acid (PLA) and/or cellulose and glue. Alternatively, the sealing layer 12c can be based on Polyhydroxyalkanoate (PHA) or based on polybutylene succinate (such as BioPBS).

Moreover, in order to facilitate the treatment of waste, the capsule 1 can also be biodegradable and/or compostable, in particular having a body made from a compostable material according to the EN 13432 standard, as for example described in the document WO-2019/185637.

Similarly, the lower film lid 7 may comprise a layer based on microfibrillated cellulose MFC, in particular having a structure identical to that of the upper film lid 12, in order to be able to combine the sealing with the waste treatment.

In particular, the materials constituting the capsule 1 and the film lids 12, 7 can be chosen to allow both industrial and domestic composting, and can be biodegradable. Advantageously, the body of the capsule 1 is produced by injection of a plastic material based on polylactic acid (PLA) or Polyhydroxyalkanoate (PHA), insofar as these materials, in addition to being compostable and compatible with food substances, allow easily producing by injection capsules 1 with thin walls, and which do not deform under the effect of heat.

In relation to such a capsule 1, four exemplary embodiments of the film lid 12 are described below.

### EXAMPLE 1

Second layer 12a: filter paper; area density 20-23 g/m²; thickness 65-85 μm; air permeability greater than 950 l/m²·s;
Layer 12b: MFC paper; area density 60-65 g/m²; thickness 50-60 μm; oxygen transmission rate less than 0.2 cm³/m²·day·atm; water vapour transmission rate 70-80 g/m²·24 h;
Sealing layer 12c: PLA; area density 15-25 g/m²; thickness 150-250 μm.

The film lid 12 according to this example has a weight in the range of 112 g and can be industrially compostable.

### EXAMPLE 2

Second layer 12a: filter paper; area density 20-23 g/m²; thickness 65-85 μm; air permeability greater than 950 l/m²·s;
Layer 12b: MFC paper; area density 60-65 g/m²; thickness 50-60 μm; oxygen transmission rate less than 0.2 cm³/m²·day·atm; on which a water vapour barrier lacquer has been applied to give it a water vapour transmission rate of less than 5 g/m²·24 h;
Sealing layer 12c: PLA; area density 15-25 g/m²; thickness 150-250 μm.

The film lid 12 according to this example has a weight in the range of 112 g and can be industrially compostable.

### EXAMPLE 3

Second layer 12a: filter paper; area density 25-30 g/m²; thickness 80-100 μm; air permeability greater than 950 l/m²·s;
Layer 12b: MFC paper; area density 60-65 g/m²; thickness 50-60 μm; oxygen transmission rate less than 0.2 cm³/m²·day·atm; water vapour transmission rate 70-80 g/m²·24 h;
Sealing layer 12c: PLA; area density 15-25 g/m²; thickness 150-250 μm.

The film lid 12 according to this example has a weight in the range of 116 g and can be industrially compostable.

### EXAMPLE 4

Second layer 12a: filter paper; area density 20-23 g/m²; thickness 65-85 μm; air permeability greater than 950 l/m²·s;
Layer 12b: MFC paper; area density 60-65 g/m²; thickness 50-60 μm; oxygen transmission rate less than 0.2 cm³/m²·day·atm; water vapour transmission rate 70-80 g/m²·24 h;
Sealing layer 12c: filter paper; area density 10-15 g/m²; thickness 40-50 μm.

The film lid 12 according to this example has a weight in the range of 110 g and can be domestically compostable.

In other exemplary embodiments, the film lid 12 may comprise only one layer 12b based on microfibrillated cellulose MFC, for example as provided in Examples 1 to 4 above, associated with a sealing layer 12c to form a two-layer film lid 12 or with a sealant lacquer to form a single-layer film lid 12.

1. An assembly comprising a capsule provided to receive a substance for preparing a beverage, said capsule comprising a body having a side wall bordered on either side by a bottom and by a rim surrounding an opening of said body, said assembly comprising an upper film lid associated with the rim (4) in order to cover the opening by forming, in said body, a loading compartment of the substance in said capsule, said opening being equipped with means for perforating the upper film lid under the effect of an increase of pressure in the compartment in order to allow the flow of the beverage through said opening, the upper film lid including a layer based on microfibrillated cellulose MFC.

2. The assembly according to claim 1, and the oxygen transmission rate of the MFC layer is at most 5 cm³/m²·day·atm, according to the ASTM D3985 standard to form a sealing layer.

3. The assembly according to claim 1, the MFC layer having a water vapour transmission rate less than 5 g/m²·24 h, measured according to the ASTM E96 standard.

4. The assembly according to claim 3, the MFC layer having been treated to improve its moisture resistance.

5. The assembly according to claim 1, the area density of the MFC layer being between 40 and 90 g/m².

6. The assembly according to claim 1, the thickness of the MFC layer being between 30 and 70 μm.

7. The assembly according to claim 1, the upper film lid including a sealing layer on the rim.

8. The assembly according to claim 1, at least one, of the body of the capsule and the upper film lid being at least one of a group of biodegradable and compostable.

9. The assembly according to claim 1, the rim forming an annular wall on which the periphery of the upper film lid is associated, the perforation means being associated with said wall by being separated from the compartment via said upper film lid.

10. The assembly according to claim 1, the bottom has an opening, said assembly comprising a lower film lid intended to cover said opening after loading the substance in the compartment.

11. The assembly according to claim 10, the bottom having a collar on which the lower film lid is associated.

12. The assembly according to claim 1, the lower film lid including a layer based on microfibrillated cellulose MFC.

13. The assembly according to claim 12, the lower film lid having a structure which is identical to that of the upper film lid.

14. The assembly according to claim 1, the upper film lid having at least one second layer made of fibrous material which is associated on the MFC layer, the layers each having an area density and an oxygen transmission rate, the area density of the second layer being less than the area density of the MFC layer, the oxygen transmission rate of the MFC layer being lower than the oxygen transmission rate of the second layer.

15. The assembly according to claim 14, the second layer based on a filter-type paper.
